(19) United States
(12) Patent Application Publication
(10) Pub. No.: US 2004/0152060 A1
(43) Pub. Date: Aug. 5, 2004

(54) Learning condition judging program and user condition judging system

(76) Inventors: Haru Ando, Kodaira (JP); Takeshi Hoshino, Kodaira (JP); Nobuhiko Matsukuma, Tachikawa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/608,335

(22) Filed: Jun. 30, 2003

(30) Foreign Application Priority Data
Jan. 31, 2003 (JP) 2003-022988

(51) Int. Cl. G09B 19/00; G09B 7/00

(52) U.S. Cl. 434/308; 434/362

(57) ABSTRACT

A program and a system for judging the learning conditions of each user from behavior information or living body information of the user, and for evaluating contents or lesson details used for learning. A change of concentration during learning is judged from a result of a blood flow rate measured in time series by a near infrared measuring device. Further, the result of the judgment and a result of analysis of user's behavior (image recognition, voice recognition and instrument input operation event) are analyzed synthetically. Thus, the change of attention of the user is extracted, and the learning conditions of the user are judged. True learning conditions of the user can be grasped in real time, and the learning contents or the lesson details can be evaluated. Further, the result of the evaluation can be reflected on the next lesson so as to enhance the learning effect.

### FIELD OF THE INVENTION

The present invention relates to an information processing apparatus for judging the learning conditions of each learner in real time in classroom education, distance education, etc., and judging the quality of learning contents or lessons from the judged learning conditions.

### BACKGROUND OF THE INVENTION

To measure the existence of education effect of each learning curriculum, methods using written examinations or questions have prevailed in conventional education sites. According to these methods, the existence of final education effect may be indeed judged, but when the education effect was poor, it is difficult to judge whether the poor education effect was due to the learner side or the teaching material or teacher side. It is therefore necessary to judge the learning conditions of each user to thereby estimate a cause of an evaluation result obtained finally. In order to determine the reason why the learning effect was poor, it is also necessary to accumulate behaviors of the user who is learning, and analyze the behaviors. Examples of the user's behaviors to be accumulated include information inputted by the user through a device or examination results of the user when the user is learning using a personal computer. These behaviors are pieces of information issued actively by the user, requiring means for judging the user's intention from these pieces of information. Apart from these pieces of information, it is necessary to provide means for acquiring information issued unconsciously by the user so as to judge the learning conditions of the user more correctly.

There is a method in which information inputted consciously by the user in response to an exercise presented by the system side, for example, event information obtained from a mouse or a keyboard is used as the information to judge the conditions of a user. On the other hand, as a method for measuring information outputted or expressed unconsciously by the user, including facial information or behavior information captured by a camera or the like, or living body information that can be measured by the measurement of the brain etc. of the user, there is a method for measuring the brain waves of the user. For example, there is also means for controlling a learning program to stop the learning program when the user is sleeping (e.g. see JP-A-6-289765) or a method for judging the degree of concentration on each chapter in a learning curriculum according to the result of measurement of the brain waves of the user (e.g. see JP-A-5-46066).

On the other hand, there has been presented a result that the degree of concentration has a positive correlation with the activation of the frontal lobe, and an Fmθ wave which is a θ rhythm appearing dominantly in the frontal lobe has a positive correlation with the degree of the concentration based on the data obtained from the brain waves (e.g. see Kawano et al. “Chronological Change in EEGs of a Child while Concentrating on Tasks” (Journal of International Society of Life Information Science (ISLIS) Vol. 20, No. 1, 2002ISSN 1341-9226, March, 2002).

As a method for measuring a brain function, there is a near infrared measurement method (e.g. see JP-A-9-149894). This method is a method in which a blood flow rate in each region of a brain is measured by extracting the rate of change in hemoglobin concentration from the region by means of near infrared light. With this method, it can be measured accurately which region is activated in the brain. To measure the degree of concentration according to this method, the rate of change in hemoglobin concentration is measured in the frontal lobe region, and the activated state of the frontal lobe region relative to the brain as a whole is judged.

As the method for extracting unconscious information by measuring a brain function, there is a measurement method using a brain wave as shown in the aforementioned related art. However, the spatial resolution of the brain wave is low because the permittivity in a living body is so uneven that the place where a signal is generated becomes ambiguous. In addition, when a user moves, the muscle potential reflects largely in the signal so as to have adverse effects on the detection of the brain wave. Therefore, there is also a constraint that the user has to be taken into custody during measurement. Thus, this method may be of no practical use to measure the brain condition of the user in everyday life.

### SUMMARY OF THE INVENTION

It is an object of the present invention to extract unconscious information accurately while keeping the degree of physical freedom of a user, and further synthetically using the extracted unconscious information and conscious information inputted in a learning curriculum by the user so that the learning conditions of the user can be judged.

To attain the foregoing object, according to the invention, conscious information obtained from a user through a mouse or a keyboard, video information of the user recorded unconsciously, and information from the brain of the user recorded unconsciously, particularly information of the blood flow rate in the brain of the user obtained from a near infrared measuring device are used synthetically to judge whether the user concentrates on and tackles a lecture or an exercise. Thus, the effectiveness or universal applicability of learning materials or lessons is judged. The following shows typical configurations of the invention to be described in this application.

That is, the invention provides a learning condition judging program including the steps of: starting up a learning program in an information processing apparatus; acquiring measurement information of a blood flow rate in a brain of a user of the information processing apparatus, the measurement information being obtained from a near infrared measuring device; acquiring input information and operation information given by the user to the information processing apparatus through input means; storing in storage means the measurement information, the input information and the operation information in association with progress of the learning program; and sending out information stored in the storage means to a connected external device. In addition, the invention provides a learning condition judging program including the steps of: acquiring, through input means, information of contents executed in a connected terminal, information of a blood flow rate in a brain of a terminal user, and operation information and input information given by the user to the terminal; analyzing a rate of change in hemoglobin concentration from the blood flow rate; judging a degree of concentration of the terminal user from the event information and the analyzed rate of change in hemoglobin concentration; and storing information of the degree of concentration in association with the contents. Further, the invention provides a user condition judging system implemented by the aforementioned program.

### BRIEF DESCRIPTION OF THE DRAWINGS

FIG. 1 is a diagram showing an example of the configuration of a system;

FIG. 2 is a diagram showing an example of the internal configuration of a server;

FIG. 3 is a diagram showing an example of the configuration of a teacher's PC 102;

FIG. 4 is a diagram showing an example of the configuration of a learner's PC 103;

FIG. 5 is a diagram showing an example of a screen for use of learning contents of a documentation system “XYZ”;

FIG. 6 is a graph showing an example of data of hemoglobin concentration measured by a near infrared measuring device;

FIG. 7 is a table showing an example of a structure of data of events issued by each user;

FIG. 8 is a table showing an example of various event analysis data 101302;

FIG. 9 is a view showing an example of a method for displaying a result in the teacher's PC;

FIG. 10 is a flow chart showing an example of a processing flow according to the present invention;

FIG. 11 is a flow chart showing an example of the processing flow according to the present invention;

FIG. 12 is a flow chart showing an example of the processing flow according to the present invention;

FIG. 13 is a flow chart showing an example of the processing flow according to the present invention;

FIG. 14 is a flow chart showing an example of the processing flow according to the present invention; and

FIG. 15 is a flow chart showing an example of the processing flow according to the present invention.

### DESCRIPTION OF THE EMBODIMENTS

This system is a system which chiefly deals with education information and which judges the learning conditions of each user as a learner, that is, as a student, while the user is learning, and displays the judgment result to the user or a teacher.

The judgment is made in the following manner.

(1) The change of concentration of the user during learning is judged from a time-series result of a blood flow rate measured by a near infrared measuring device by a living body measuring method which is high in spatial resolution and in which measurement can made while giving the user a high degree of physical freedom. Further, the change of attention of the user is extracted from an analysis result of user's behavior (image recognition, voice recognition and instrument input operation events). Thus, the learning conditions of the student is judged.

(2) Results of written examinations and the attention information or the concentration information obtained from the result of the paragraph (1) are analyzed synthetically so that the effect of the lesson is judged comprehensively.

(3) The judgment result is displayed to the teacher or the student in the form of a sound or an image.

(4) The effectiveness or universal applicability of learning materials or lessons is evaluated from the judgment results of a plurality. of students.

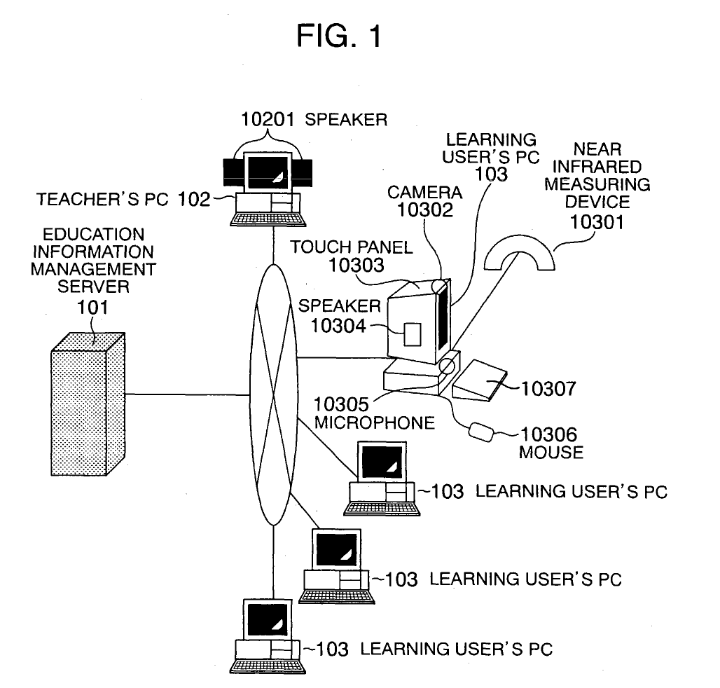

An embodiment of the present invention will be described below with reference to the drawings. First, the embodiment of the invention will be described with reference to FIG. 1. FIG. 1 is a diagram showing the system configuration of the invention. The reference numeral 101 represents an education information management server for accumulating learning-related information and analyzing the accumulated information. The reference numeral 102 represents a PC to be used by a teacher who is giving an education; and 103, a PC to be used by a user who is learning. The teacher's PC is mounted with a speaker 10201 for notifying the teacher of the learning conditions of the learning user. The learning user's PC 103 is mounted with a near infrared measuring device (brain topography) 10301 for measuring the brain blood flow rate in each region of the brain of the learning user, a camera 10302 for photographing/recording an image of the learning user who is learning, a touch panel 10303 for allowing the learning user to input through a screen, a speaker 10304 for notifying the learning user of his/her own learning conditions, and a microphone 10305 for acquiring and recording a voice or the like uttered by the learning user. A plurality of such learning user's PCs can be connected to the server. As for the overall operation of the system, when a user uses the learning user's PC to learn along the contents of learning materials transmitted from the education information management server 101, the conditions in which the learning user is learning are recorded by the learning user's PC, and the recorded data is transmitted to the education information management server. The learning conditions of the learning user are extracted from the transmitted recorded data, and the extracted data is transmitted to the teacher's PC or the learning user's PC. Detailed description will be made as follows.

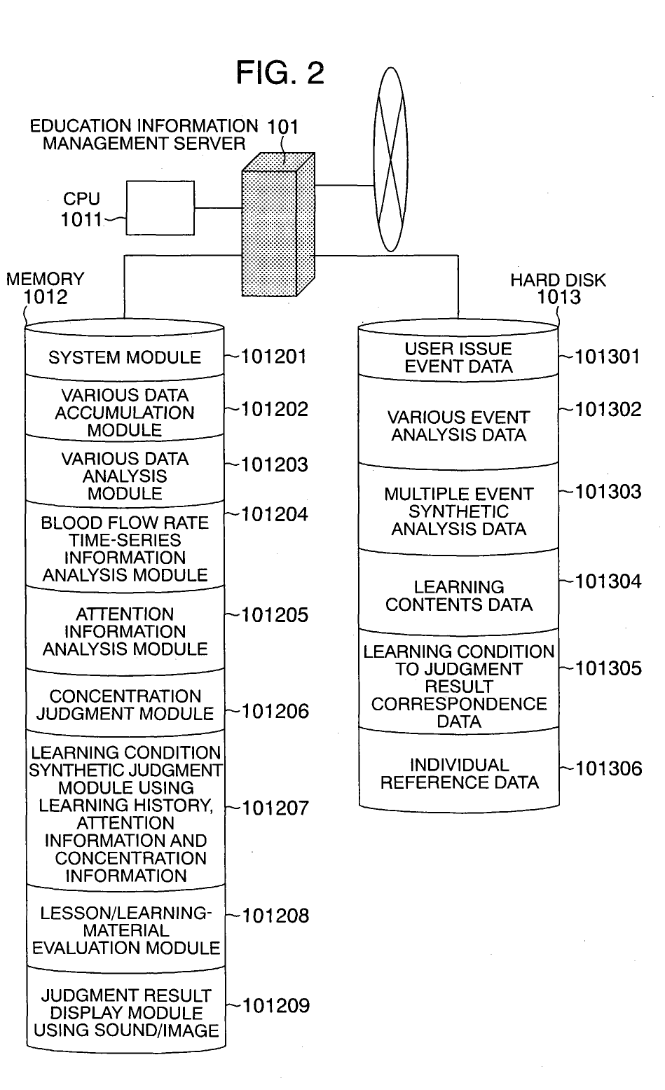

First, at the beginning, description will be made on the education information management server 101 with reference to FIG. 2. The reference numeral 1011 represents a CPU for performing processing in accordance with a program started up; 1012, a memory for storing the started-up program and the like; and 1013, a hard disk for storing memory data and the like. Data to be accessed is read onto the memory 1012 in accordance with necessity, and subjected to data processing according to the present invention by the CPU 1011. User issue event data 101301 including events issued by users, various event analysis data 101302, multiple event synthetic analysis data 101303, learning contents data 10304 and learning condition to judgment result correspondence data 101305 are stored in the hard disk 1013. In addition, once the server is booted up, the memory 1012 stores a system program 101201 for controlling the system as a whole, a various data accumulation module 101202, a various event analysis module 101203, a blood flow rate time-series information analysis module 101204, an attention information analysis module 101205 based on event analysis, a concentration judgment module 101206, a learning condition synthetic judgment module 101207 using a learning history, attention information and concentration information, a lesson/learning-material evaluation module 101208, and a display module 101209 for displaying the judgment result by means of sound/images.

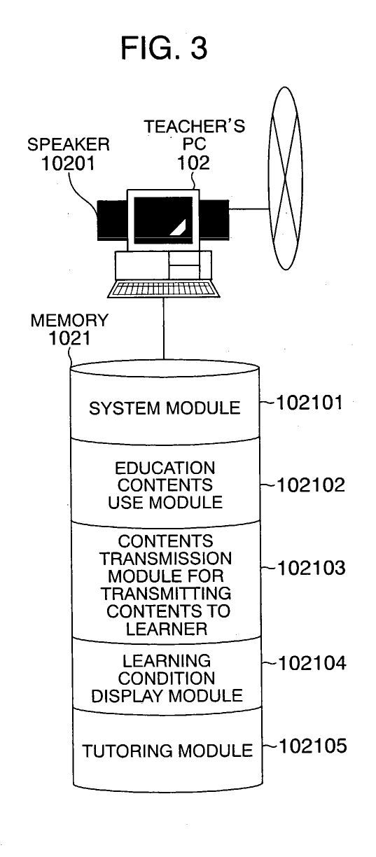

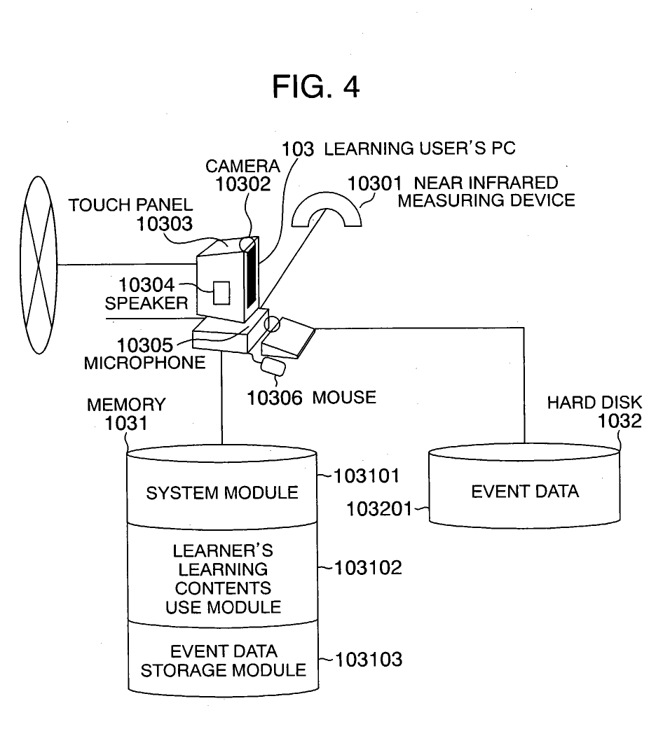

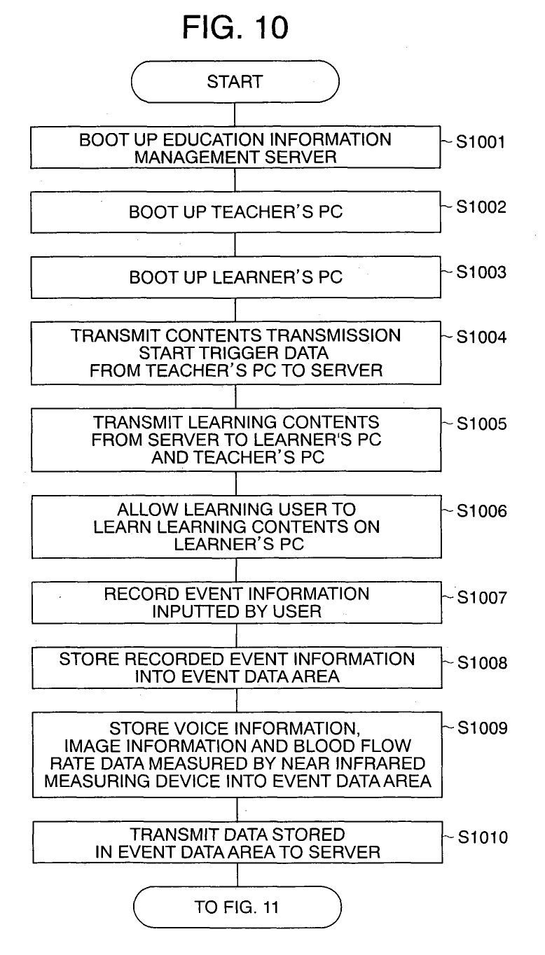

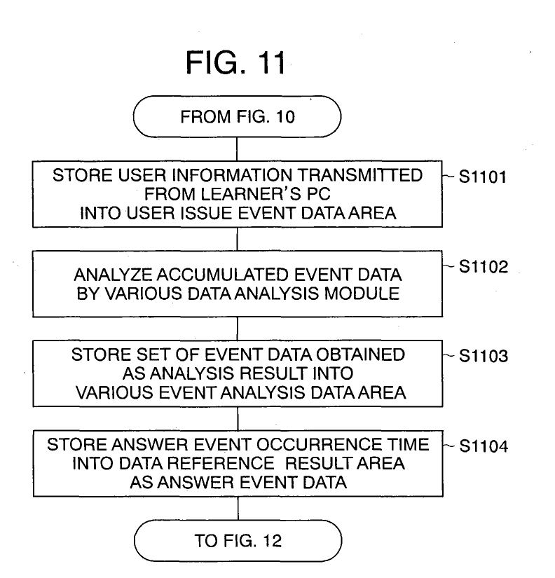

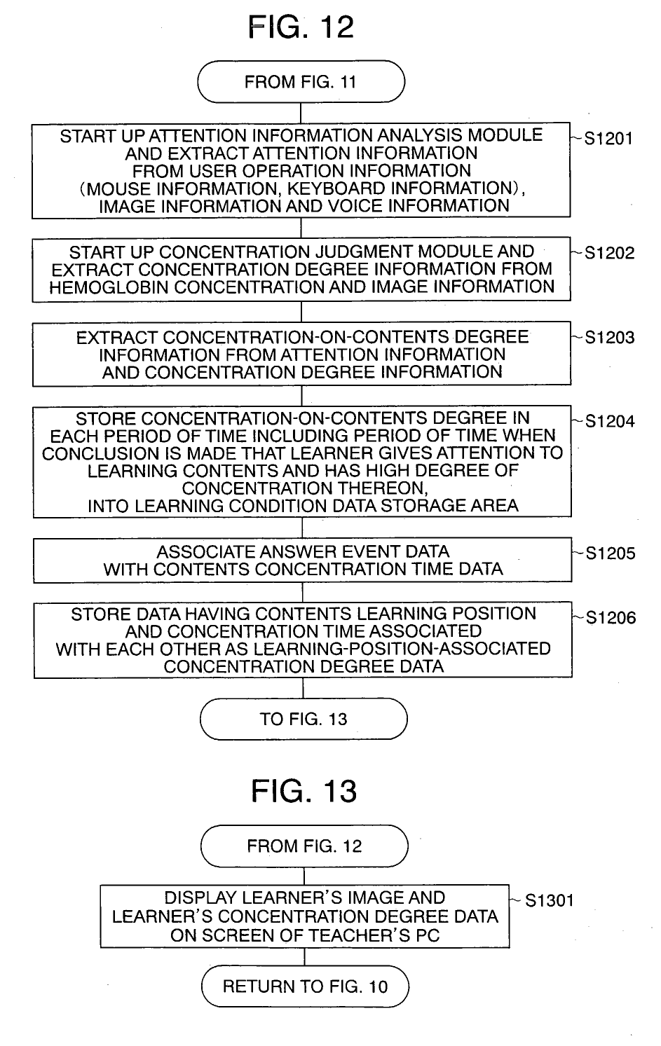

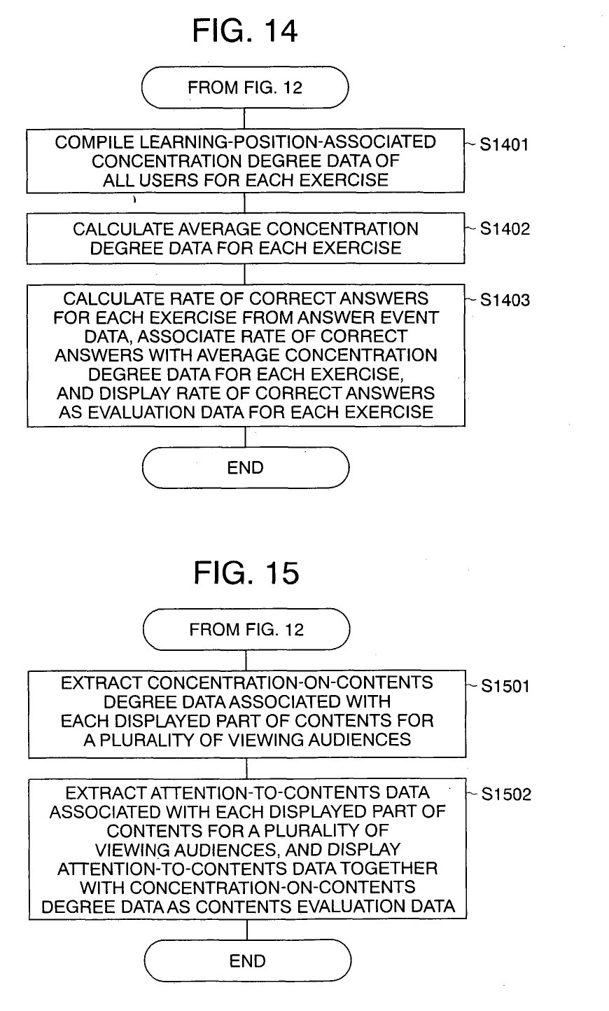

Next, processing in this apparatus will be described with reference to FIGS. 10-15. First, the education information management server 101 is booted up (S1001). Suppose that the education information management server 101 is always running. Further, the teacher's PC 102 is booted up (S1002). FIG. 3 shows the configuration of the teacher's PC. The teacher's PC 102 is provided with a memory 1021, and mounted with the speaker 10201 if necessary. When the teacher's PC is booted up, a system module 102101 for managing the operation, an education contents use module 102102 to be used for using the education contents, a contents transmission module 102103 for transmitting the contents to each learner, a learning condition display module 102104 for displaying the learning conditions of each learner, and a tutoring module 102105 to be actuated when the teacher tutors each learner, are stored in the memory 1021. Next, the learning user's PC is booted up for each learning user (S1003). In this embodiment, assume that when a learning contents transmission start trigger data is transmitted to the server 101 by the contents transmission module 102103 for transmitting the learner-addressed contents from the teacher's PC to one or plural learning user's PCs having already been booted up (S1004), the learning contents are distributed from the server 101 to the learning user's PCs (S1005). Next, FIG. 4 shows the configuration of the learning user's PC to be used by a leaning user. The learning user's PC is mounted with a memory 1031, which has been loaded with a system module 103101 for booting up and managing the learning user's PC, a learner's learning contents use module 103102 to be actuated when the leaner uses the learning contents, and an event data storage module 103103 for temporarily storing events issued by the user. The learner starts up the learner's learning contents use module and waits till the learning contents are transmitted to the learner. Then, the learner starts up the learning program. Alternatively, when the learning contents have already been stored in the learner's PC, the learner may receive only a permission signal for permitting the learner to start up the learning contents.

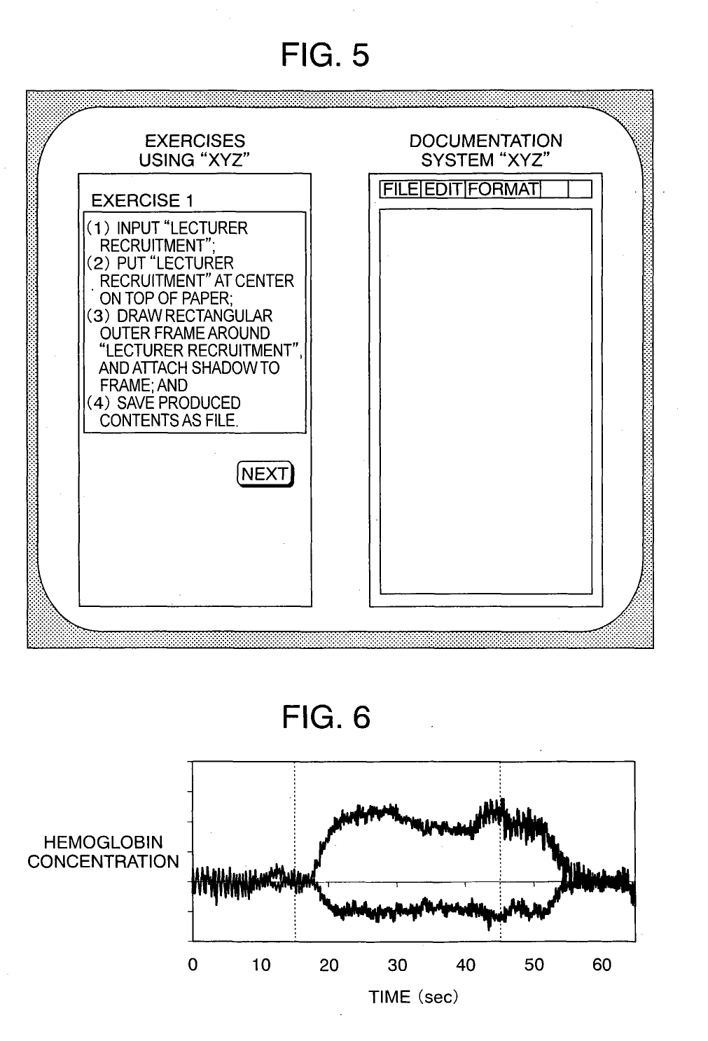

For example, assume that “learning contents of documentation system “XYZ”” are transmitted as learning contents from the server to a learning user's PC. When the learning contents are transmitted to the learning user's PC, a screen as shown in FIG. 5 is displayed on the learning user's PC. For example, an exercise of documentation is displayed on the “learning contents of documentation system “XYZ”” on the left side of the screen, and the learning user inputs and edits this exercise through the “documentation system “XYZ”” displayed on the right side of the screen. Assume that the learning user solves the exercise shown in “Exercise 1” of FIG. 5. On this occasion, the same screen learner's contents are also displayed on the teacher's PC. As soon as the learning contents are transmitted to the learning user, the learning user starts learning on the “documentation system “XYZ”” in accordance with the instructions of this exercise (S1006).

The learning user performs documentation and edition through a mouse 10306 or a keyboard 10307 in the case of this exercise. At this time, operation information such as mouse events or keyboard events and input information such as voice information or text input, which are inputted consciously through the mouse, the keyboard, etc. by the user; utterance information and user's images, which are information having a tendency to be issued unconsciously by the user; and information of the blood flow rate in the brain of the user acquired through information acquiring means, are recorded (S1007).

Specifically, information inputted through the mouse 10306, the keyboard 10307, the microphone 10305, the camera 10302 and the near infrared measuring device 10301 is accumulated. Incidentally, any information other than the information inputted through the above devices can be used if it is information from means for inputting instructions to the apparatus or information usable for judging the learning conditions of the user. The inputted information is stored in an event data area 103201 on the hard disk 1032 (S1008 and S1009). The information once stored in the event data area 103201 is transmitted to the server 101 (S1010), and stored in the user issue event data area 101301 on the hard disk 1013 by the various data accumulation module 101202 (S1101). Further, the accumulated event data is analyzed by the various data analysis module 101203 (S1102). The various data analysis module includes sub-modules such as a mouse event analysis sub-module, a keyboard event analysis sub-module, a voice recognition sub-module, a video recognition sub-module and a near infrared data analysis sub-module. For example, the stored voice information is converted into text information by the voice recognition sub-module, and facial expression information or head behavior information is extracted from the accumulated video information by the video recognition sub-module. From the hemoglobin concentration recorded by the near infrared measuring device, the rate of change in hemoglobin concentration is extracted by the blood flow rate time-series information analysis module 101204. The details of the methods for recognizing the voice information, the video information and the near infrared data information will be described later.

The information accumulated in the event data area is stored in the various event analysis data area 101302 as a data set of event occurrence time, event end time and event details for each event (S1103). Here, the event means information of operation performed on a terminal by a user of the terminal. For example, as for input information from a mouse, each event designates a push operation, a release operation or a drag operation of the mouse. As the event occurrence time on the push operation, the time when the mouse was pushed and the information of the screen position where the mouse was pushed are recorded. As the event occurrence time of event data in the drag operation, the time when the drag was started and the information of the mouse pointer position on the displayed contents are recorded, and as the event end time of event data in the drag operation, the time when the drag was terminated and the information of the mouse pointer position on the displayed contents are recorded. In the case of voice information, a start time of a voice is recorded as a start event, an end time of the voice is recorded as an end event, and event details are recorded as voice information. In the case of video information, all the information to be recorded is an event. Therefore, the result of the facial expression information or the head behavior information of a user extracted from the recorded information is stored as event details information. The start and end times of the event correspond to the occurrence time and end time of the extracted event. In the case of the brain blood flow rate information, all the information to be measured is an event, like the video information. Therefore, the measured rate of change in hemoglobin concentration is recorded as an event, for example, every 10 seconds.

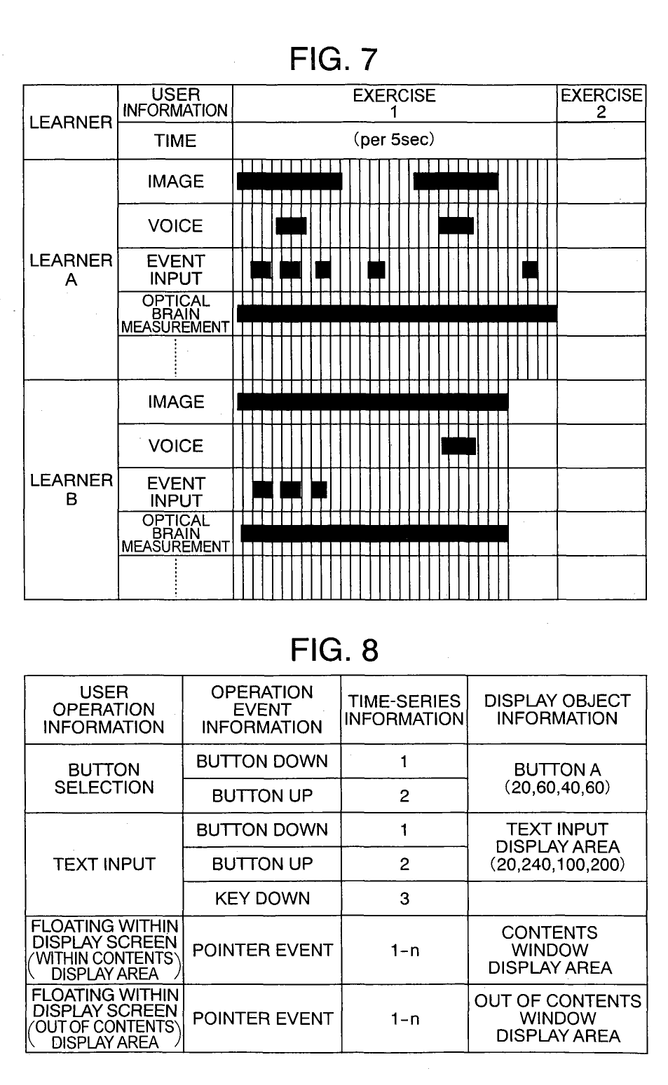

In addition, at this time, each data set is tagged with a personal ID by which a learning user can be identified. The personal ID of each learning user is registered in the server when the learning user performs learning for the first time. FIG. 7 shows an example of the structure of the various event analysis data.

On the other hand, coordinates indicating a button display area, a menu display area and an information input area of the displayed learning contents are stored in the learning contents data 101314. Further, information of these coordinate values combined with a plurality of operation events, and information of the order with which the operation events will occur in time series in a correct answer are registered. For example, consider an event of pushing a “File” button. The event is stored as combination information of a plurality of operation events on the assumption that information that the “File” button was pushed can be obtained when a button down event and a button up event occurred sequentially in time series within the display area of the “File” button. As for the operation event time-series information in a correct answer, for example, assume that the (1) of Exercise 1 in FIG. 5 is performed. In this case, a push event of a mouse pointer within a text input area, a key input event “Lecturer Recruitment”, and a return key input event are stored in time series as a sequence of events required for arrival at the correct answer. Further, correct answer text data “Lecturer Recruitment” is stored.

The learning contents data is checked with the mouse event data and the keyboard event data in the various event analysis data by use of the attention information analysis module 101205 based on event analysis. The time and event in which the user issued a correct answer event are stored in a data check result area as answer event data. As for an incorrect answer event issued in a contents learning stage in which the correct answer event should be issued, the event occurrence time and the answer event details are also stored as answer event data (S1104).

Next, description will be made on the method for recognizing the near infrared data, the image data and the voice data. The near infrared data is judged by the blood flow rate time-series information analysis module 101204. For example, assume that there is obtained a rate of change in hemoglobin concentration such that a hemoglobin value higher by 150% than the hemoglobin value in a normal blood flow rate of each individual learning user awaking, the hemoglobin value has been stored in an individual reference data 101306 of the learning user, continues for 30 or more seconds. In this case, it is concluded that the degree of concentration of the learning user has increased. As for the image data, facial information and head behavior information of the learner are recognized by the image recognition sub-module in the various data analysis module 101203. For example, facial information is recognized in a method for recognizing expression using an optical flow as disclosed in “A Prototype of a Real-time Expression Recognition System from Dynamic Facial Image” (Journal of Human Interface Society, Vol. 1, No. 2, 1999, Shimoda et al., p.p. 25-32, May 1999). For example, assume that a “front image”, a “side image” and a “head portion” are prepared in advance as templates for facial information, and stored in the individual reference data 101306. A camera makes judgment as to whether the leaner is present in front of the screen or not, judgment as to the direction of the head of the learner, and judgment as to the expression of the learner. As a recognition result, the period of time when the facial image of the learner is being recognized, the direction (front (a), side (b) or head (c)) of the facial image and the expression tag are stored in an event data check result area on the memory as a data set. As for the voice information, the voice wave is recognized by the voice recognition sub-module in the various data analysis module, and text information is extracted therefrom. The text information is stored in the various event analysis data area in the form of a data set of the start time and the end time of the text information.

The data obtained by the aforementioned means is further analyzed synthetically so that the learning conditions of the learner is judged. The attention information analysis module 101205 is started up (S1201), so as to extract the attention information from the user operation information and the image data information. For example, when an event of the user operation information such as a mouse event or a keyboard event occurs within the window of the learning contents, it is concluded that the learner's attention is given to the learning contents. FIG. 8 shows the structure of such data. On the other hand, when such an event occurs out of the window of the learning contents, it is concluded that the learner's attention is given to something other than the learning contents. Further, the concentration judgment module is started up (S1202). When the start time and the end time of high hemoglobin value data are included in a period of time between the start time and the end time of the facial image data (a), it is concluded that the degree of concentration is high in that period of time. Further, when the user operation information is generated within the learning contents display area at that period of time, it is concluded that the user concentrates on the given learning contents. In the case of other situations, such as, a situation that a high hemoglobin value is observed but the facial image of the user is not recognized or the head portion image of the user is recognized during the period of time when the high hemoglobin value is observed, or a situation that a high hemoglobin value is observed but the user operation information is generated in an area out of the learning contents display area, it is concluded that the user concentrates on something other than the learning contents. In addition, when a word included in the text information obtained as a result of recognition of the voice information is similar to a word used in the learning contents, or when a sentence included in the text information is equal to a general interrogative sentence such as “What is it?”, “What is this?” or “I don't know”, and when a high hemoglobin value is observed, it is concluded that the user's attention is given to the learning contents (S1203). The period of time when it was concluded that the user's attention was given to the learning contents and the degree of concentration was high is stored in the learning condition data storage area as contents concentration time data (S1204).

Next, the answer event data is associated with the contents concentration time data (S1205). The contents concentration time data is associated with an answer event occurrence time as a reference feature quantity. For example, when the contents concentration time is associated between an answer event occurrence time A and an answer event occurrence time B, it is concluded that the user concentrates on and gives attention to the contents of an exercise corresponding to the answer event occurrence time B. Data having the contents learning position and the concentration time associated with each other is stored as learning-position/concentration-degree data (S1206).

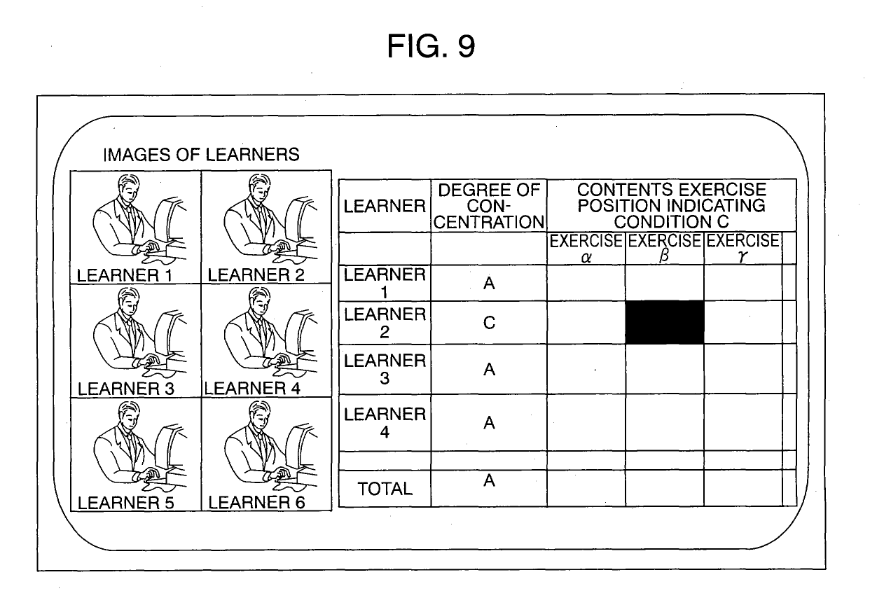

Next, description will be made on an embodiment of a method in which the judgment result of the learning conditions extracted in such a manner is displayed on the teacher's PC. When the teacher conducts a lesson in real time, images of learners and concentration degree data of the learners are displayed on the screen of the teacher's PC as shown in FIG. 9 (S1301). As the concentration degree data, A is marked when the degree of concentration is high, and B or C is marked when the degree of concentration is low. When the degree of concentration is low, the period of time when a low degree of concentration was measured and the contents learning position corresponding to the period of time may be also displayed. In addition, in order to notify the learner of the lowering of the degree of concentration, a warning voice such as “Your concentration is slipping.” using a recorded voice or the like is outputted from the speaker of the learner's PC when the degree of the concentration is concluded as B or C. Statistics for the distribution of the degree of concentration by each learner can be also gathered.

In addition, learning-position/concentration-degree data after the education based on the learning contents is given is compiled for each exercise (S1401), and average concentration degree data for each exercise is calculated (S1402). Further, a rate of correct answers for each exercise is calculated from the answer event data and displayed as evaluation data (S1403). Learning materials can be evaluated from the average concentration degree data and the rate of correct answers in so that exercises are classified into an exercise allowing learners to concentrate thereon but with a low rate of correct answers, an exercise allowing learners to concentrate thereon and with a high rate of correct answers, etc.

Further, the present invention is also applicable to various contents other than learning materials. For example, the conditions in which a user is watching video contents are judged, and the degree of concentration and the degree of attention for each displayed part of the video contents are calculated in accordance with the degree of concentration based on utterance information (e.g. laughing voice), user's video data or near infrared data (S1501). Thus, the degree of concentration and the degree of attention can be displayed (S1502) for use as feature quantity data for estimating the rating etc. of the contents.

As described above, the present invention is:

(1) applicable to management of the degree of concentration during distance and simultaneous education;

(2) applicable to judgment of the degree of accomplishment in a learning curriculum;

(3) applicable to judgment of the quality of learning materials used in lessons and learning;

(4) usable regardless of use language because information independent of language is used; and

(5) capable of making a teacher grasp the conditions of students located in a place remote from the teacher, for example, in an overseas place so as to give timely support to the students.

Incidentally, the configuration of the present invention is applicable not only to learning programs but also to a system making a request to a terminal for input or operation in accordance with a program, such as a questionnaire collecting program or the like.

According to the present invention, it is possible to grasp true learning conditions including the degree of concentration, etc., of each learner in real time, and it is possible to reflect the analyzed learning conditions on the next lesson so as to enhance the learning effect. In addition, the invention is also applicable to a method for evaluating various contents other than learning contents, and the contents using conditions by users can be judged regardless of the locations of the users.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A learning condition judging program to be executed in an information processing apparatus connected to a near infrared measuring device, comprising the steps of:
starting up a learning program in said information processing apparatus;
acquiring measurement information of a blood flow rate in a brain of a user of said information processing apparatus, said measurement information being obtained from said near infrared measuring device through information acquiring means;
acquiring input information and operation information given by said user to said information processing apparatus through input means;
storing in storage said measurement information, said input information and said operation information in association with progress of said learning program; and
sending out information stored in said storage to a connected external device.

2. A learning condition judging program according to claim 1, further comprising the step of:
acquiring audio or video information of said user of said information processing apparatus through at least one of a microphone and a camera connected to said information processing. apparatus;
wherein said audio or video information is also recorded in said storing step.

3. A learning condition judging program comprising the steps of:
acquiring, through input means, information of contents executed in a connected terminal, information of a blood flow rate in a brain of a user of said terminal, and operation information and input information given by said user to said terminal;
analyzing a rate of change in hemoglobin concentration from said blood flow rate;
judging a degree of concentration of said user of said terminal from operation and input information and said analyzed rate of change in hemoglobin concentration; and
storing information of said degree of concentration in association with said contents.

4. A learning condition judging program according to claim 3, further comprising the step of:
displaying said information of said degree of concentration on display.

5. A learning condition judging program according to claim 3, further comprising the step of:
acquiring audio or video information of said user of said terminal, said audio or video information being acquired through at least one of a microphone and a camera connected to said terminal;
wherein said step of judging said degree of concentration also uses said audio or video information.

6. A learning condition judging program according to claim 4, further comprising the step of:
acquiring audio or video information of said user of said terminal, said audio or video information being acquired through at least one of a microphone and a camera connected to said terminal;
wherein said step of judging said degree of concentration also uses said audio or video information.

7. A learning condition judging program according to claim 3, further comprising the step of:
giving notice to said user of said terminal in accordance with a result of said step of judging said degree of concentration.

8. A learning condition judging program according to claim 4, further comprising the step of:
giving notice to said user of said terminal in accordance with a result of said step of judging said degree of concentration.

9. A learning condition judging program according to claim 4, further comprising a step of judging whether said input information is a correct answer to an exercise included in said learning contents or not is further provided; and
said concentration degree judging step makes said judgment also using a result of said answer judging means.

10. A learning condition judging program according to claim 5, wherein:
answer judging means for judging whether said input information is a correct answer to an exercise included in said learning contents or not is further provided; and
said concentration degree judging step makes said judgment also using a result of said answer judging means.

11. A learning condition judging program according to claim 9, further comprising the step of:
displaying, on a display, information of said degree of concentration and information of a rate of correct answers for each exercise included in said learning contents, said rate of correct answers being obtained from said judgement result of said answer judging means.

12. A learning condition judging program according to claim 10, further comprising the step of:
displaying, on a display, information of said degree of concentration and information of a rate of correct answers for each exercise included in said learning contents, said rate of correct answers being obtained from said judgement result of said answer judging means.

13. A system comprising a near infrared measuring device, a terminal connected to said near infrared measuring device, and a server connected to said terminal through a network:
said server including recording means for recording contents information;
said terminal including:
means for acquiring information from said near infrared measuring device;
a display for displaying said contents information received from said server; and
input means for accepting input instructions and operation instructions for said displayed information;
said server further including:
a storage for storing inputs from said input means, said information from said near infrared measuring device, and said displayed contents information in association with one another; and
means for judging conditions of terminal user's tackling said contents, based on information stored in said storage means.
